(19) United States
(12) Patent Application Publication
(10) Pub. No.: US 2006/0270520 A1
(43) Pub. Date: Nov. 30, 2006

(54) Control system for an automatic transmission

(76) Inventor: Kevin M. Owens, Tampa, FL (US)

Correspondence Address: KEATY PROFESSIONAL LAW CORPORATION;THOMAS S. KEATY, 2 CANAL STREET, 2140 WORLD TRADE CENTER, NEW ORLEANS, LA, 70130, US

(21) Appl. No.: 11/138,189

(22) Filed: May 26, 2005

(51) Int. Cl. F16H 61/26

(52) U.S. Cl. 477/134

(57) ABSTRACT

An electronic control for an automatic transmission of a vehicle, such as a motorcycle, has a central processing unit with a memory for storing control parameters for controlling the functions of the transmission and a processor for processing signals indicative of movement of the vehicle. The control system employs various sensors to facilitate smooth switching of gears in the automatic transmission, the sensors including speed sensor, tachometer, solenoid line pressure sensors and a throttle sensor. A user interface allows the user to selectively override pre-programmed gear selection of the transmission and choose operation at lower or higher gears.

### BACKGROUND OF THE INVENTION

The present invention relates to a transmission system for a vehicle, and more particularly to a transmission for a motorcycle-type vehicle or the like.

Conventional motorcycles allow the rider to control the use of the motorcycle without removing the user's hands from the handlebars. In most conventional motorcycles, the control system uses a manual transmission. Suitable torque, or turning force, is generated by the engine only within a narrow range of engine speeds, i.e., rates at which the crankshaft is turning. However, the wheels must turn with suitable torque over a wide range of speeds. While its speed is held roughly constant, the engine turns an input shaft on the transmission whose output shaft can be adjusted to turn the wheels at an appropriate speed.

The manual transmissions consist of a system of interlocking gearwheels. These wheels are arranged so that by operating a lever on the handlebar, the driver can choose one of several ratios of speed between the input shaft and the output shaft. The first gear gives the lowest output speed, second gear the next lowest, and so forth. To allow smooth shifting from one gear to another, a clutch is provided to disengage the engine from the transmission. When the rider takes his hand off the clutch lever, springs squeeze the friction disk into the space between the flywheel and the pressure plate, enabling the engine shaft to turn the transmission. However, the manual transmissions in motorcycles suffer the same disadvantages as manual transmission on any other type of vehicle—they require additional movement by the user and continuous attention to the speed of the motorcycle.

The shift switch with an upshift button and a down shift button are provided on the right handle bar while the left handle bar has normal clutch lever mounted thereon. In operation, the user depresses the clutch lever and the up shift button which causes the upshift control solenoid to open to permit a burst of air to flow to the actuator and change the transmission gear ratio. The downshifting is performed by pushing the down shift button.

An automatic transmission in a vehicle switches to the optimum gear without driver intervention except for starting and going into reverse. The type of automatic transmission used on current American cars usually consists of a fluid torque converter and a set of planetary gears. The torque converter transmits the engine's power to the transmission using hydraulic fluid to make the connection. For more efficient operation at high speeds, a clutch plate is applied to create a direct mechanical connection between the transmission and the engine. The 4-5 speed automatic transmissions that are available in automobiles are not currently available in the motorcycle industry.

A continuously variable transmission (CVT) uses a belt that connects two variable-diameter pulleys to provide an unlimited number of ratio changes and uninterrupted power to the wheels. CVT transmissions offer better fuel efficiency than conventional automatic transmissions, which change the transmission ratio by shifting gears. There are numerous problems associated with the CVT-type transmission. One of the problems is that this type of design requires tension on the belt/chain at all times, otherwise the belt tends to slip. This means that one pulley must expand/contract exactly in accordance with the other pulley, creating a task of keeping the tension on the belt at all times as it moves up and down the center groove of the two pulleys.

Additionally, the CVT-type transmissions have certain limitations, such as the pulley drive consisting of a belt with numerous metal links that are held together by being sandwiched between an upper and lower rubber belts. If the belt breaks down, it releases all the metal links with the transmission case or a slick belt slips. Additionally, the CVT transmission results only in two speed transmission, high and low, not a four or five speed automatic transmission available in conventional land vehicles.

Further, the motorcycle version of the CVT transmission is limited due to its size and cannot be fitted to motors larger than 1100 cc. Even further, a CVT transmission cannot handle the power of the large motors due to belt slippage. While this type of transmission works satisfactory under some conditions, it may develop a problem over a period of time due to the presence of multiple mechanical links and may not hold up in a high performance situation.

The present invention contemplates elimination of drawbacks associated with the prior art and provision of a device for regulating and enabling an automatic transmission that can be used with motorcycle-type vehicles providing convenience and ease of operation for the user.

### SUMMARY OF THE INVENTION

It is, therefore, an object of the present invention to provide a control system for an automatic transmission system which does not require manual right and left handle bars coordination of movement.

It is another object of the present invention to provide a user-friendly automatic transmission control system which allows for a smooth shifting between the gears with an automatic control provided by a central processing unit.

It is a further object of the present invention to provide an automatic transmission control system, which uses a central processing unit to receive data signals from a plurality of sources associated with operation and movement of the motorcycle.

These and other objects of the present invention are achieved through a provision of an electronic transmission control system for controlling the functions of a transmission in a land vehicle, such as a motorcycle equipped with an engine. The control system comprises an electronic transmission controller having a memory for storing control parameters for controlling the functions of the transmission and a processor for processing signals indicative of movement of the motorcycle and a user interface device with a display thereon for communicating with the controller. A plurality of sensor means detect various functions of the vehicle operation, such as speed of rotation of the motorcycle engine, speed of movement of the motorcycle, position of a motorcycle throttle, and solenoid line pressure. The interface device is connected to the controller for sending overriding signals to the controller and selectively controlling operation of the transmission.

### BRIEF DESCRIPTION OF THE DRAWINGS

Reference will now be made to the drawings, wherein like parts are designated by like numerals and wherein

FIG. 1 is a schematic view of a motorcycle, in which the control system for the automatic transmission in accordance with the present invention can be used.

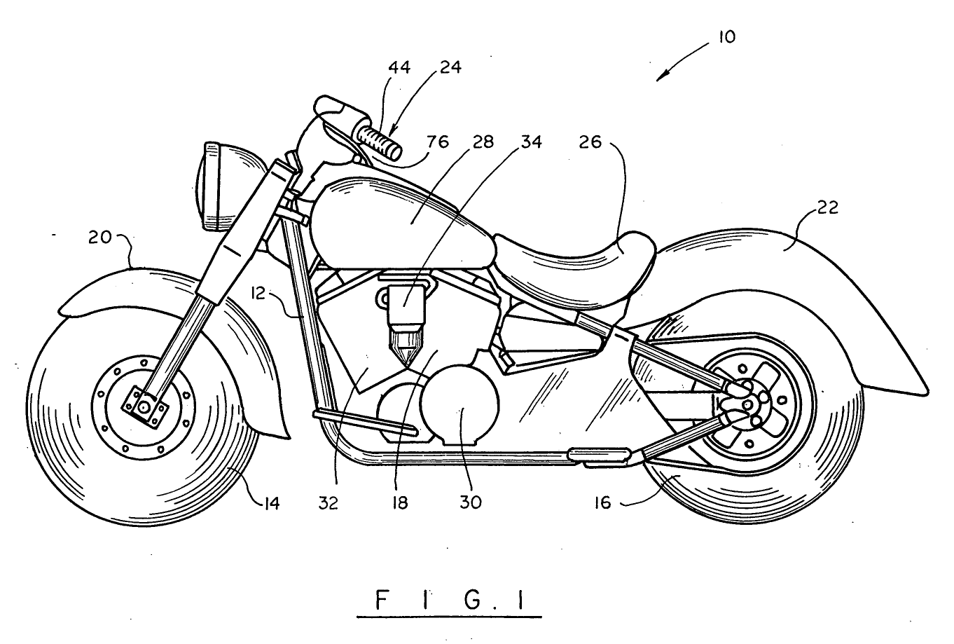

FIG. 2 is a schematic view of the automatic transmission control system of the present invention.

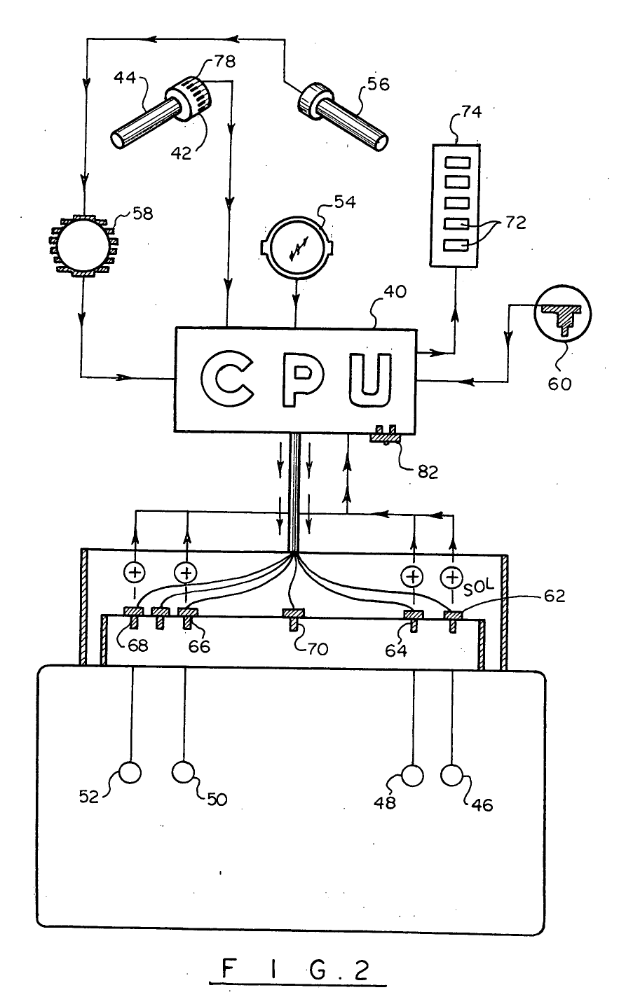

FIG. 3 is a schematic view of the automatic transmission control system of the present invention using a variation of the gear shifting means.

### DETAILED DESCRIPTION OF THE PREFERRED EMBODIMENT

Turning now to the drawings in more detail, numeral 10 designates a motorcycle in which the automatic transmission control system of the present invention can be employed. The motorcycle has a frame 12, which supports the engine/transmission assembly for operating the motorcycle. Mounted on the frame 12 is a front wheel 14 and a rear wheel 16 rotatable by an internal combustion engine 18. The front wheel 14 is protected by a front wheel fender 20, while the rear wheel 16 is protected by a rear wheel fender 22. A handle bar 24 controls operation and direction of movement of the front wheel 14.

A rider seat 26 is supported by the frame 12 behind a fuel tank 28. A transmission assembly 30 is connected to the cylinder block 32 of the engine assembly. A carburetor assembly 34 is positioned between the cylinder blocks 32 of the engine assembly.

In order to change transmission speeds, the rotational motion from one set of gears positioned in the motorcycle engine is transmitted to another set of gears which form a part of the engine assembly. The switching of the gears is effected by engaging and disengaging of clutch packs which receive oil pressure from the oil reservoir. When the engine is started, the pressure is relatively high, in the order of 150 pounds and, if engaged at once, it results in a jumping or jerking movements of the motorcycle. By regulating the pressure into the clutch packs through the solenoids, the present invention allows to deliver gradually increasing oil pressure from 20 pounds to a full engagement with the pressure of about 150 pounds.

The control system of the present invention comprises an electronic central processing unit, or CPU 40, which processes signals received from control buttons and a number of sensors operationally connected to the operating parts of the motorcycle 10. The microprocessor 40 controls operation of electronic sensors, which enhance the performance of the automatic transmission. As described in more details hereinafter, data about engine speed, exhaust pressure, and other performance characteristics are sent to the processor 40, which controls the switching of gears and the clutch plate in the torque converter via electrical switches, or solenoids.

The CPU 40 stores control parameters for controlling the functions of the transmission 30 and has a processor for processing data indicative of the motorcycle functions, such as motor RPMs, speed of movement, degree of opening of the throttle and function of the solenoids in a location where the solenoids act on the engine valves. The pressure sensors regulate the amount of oil pressure sent to the clutch pack of the engine through the solenoids.

To start moving, the user selects the speed, for instance Drive by pushing one of the buttons 42 positioned on a left grip 44 of the motorcycle. The signal from the control button 42 is transmitted to the central processing unit 40, which will energize the first gear 46, then the second gear 48, the third gear 50 and the fourth gear 52 in sequence, depending on the speed of the movement.

As the road speed of the motorcycle 10 increases, the CPU 40 energizes the respective electrically operated solenoid valves (not shown) while simultaneously releasing the first gear 46 to achieve the second gear 48. Only one set of gears can be engaged at one time. The increase in speed of movement of the motorcycle 10 causes the CPU 40 to regulate switching of gears to the third gear 50 and then to the fourth gear 52, one at a time.

The shift in gears and timing of the switch between the gears is determined by the central processing unit 40 depending on a variety of signals received by the central processing unit. The control system of the present invention employs one or more of sensing means that detect the operational condition of the vehicle at a given time. One of the data signals received by the central processing unit 40 is the speed of the revolutions of the motor (RPM) as detected by a tachometer 54. Another set of data, which may be employed in detecting the operational position of the vehicle is a throttle sensor, where a throttle 56 sends a signal to a throttle position sensor 58. The signal from the sensor 58 is transmitted to the central processing unit 40. The throttle position sensor 58 detects the amount of fuel delivered to the motor.

Still another set of data may be collected by a speed sensor 60, which receives data from the speedometer and sends the signal for processing by the central processing unit 40 in combination with other data received from the throttle sensor 58 and the tachometer 54. Additionally, each of the solenoids 62, 64, 66, and 68 has sensors which send signals to the central processing unit 40 for processing. These signals are combined with a signal from a pressure sensor 70, which is also input into the central processing unit 40 as a signal of operating condition of the vehicle hydraulic system (not shown). The CPU 40 also receives a signal from the ignition 82 (positive and ground).

The current position of the transmission is shown by indicators in one of the control panel windows 72 of a gear position indicator, or display means 74, which is mounted on the panel 76 forming a part of the handle bar assembly 24. The indicators in the control panel windows 72 can show when the transmission is in a neutral position, a drive position, first, gear, second gear, third gear, etc.

Under some circumstances, the user may desire to retain the transmission in low gear, such as when moving slowly or driving on a steep hill. The present invention provides for a means to override the control signal of the CPU 40. A selected button 42 on the gear shifting assembly 78 can be depressed to hold the transmission in the selected gear. For instance, if the user pushes the third gear button, the transmission will remain in the third gear. If the user chooses to press the button corresponding to the second or the first gear, the transmission will remain in second or third gear, respectively.

The user may also perform gear selection depending on the desired effect of movement of the motorcycle 10. For instance, when the person desires to do a burnout, the user will press the hold button in the first gear and the transmission will not up shift until the button is depressed again. The transmission will then begin to up shift to the next gear ratio until or unless the hold button is pressed again.

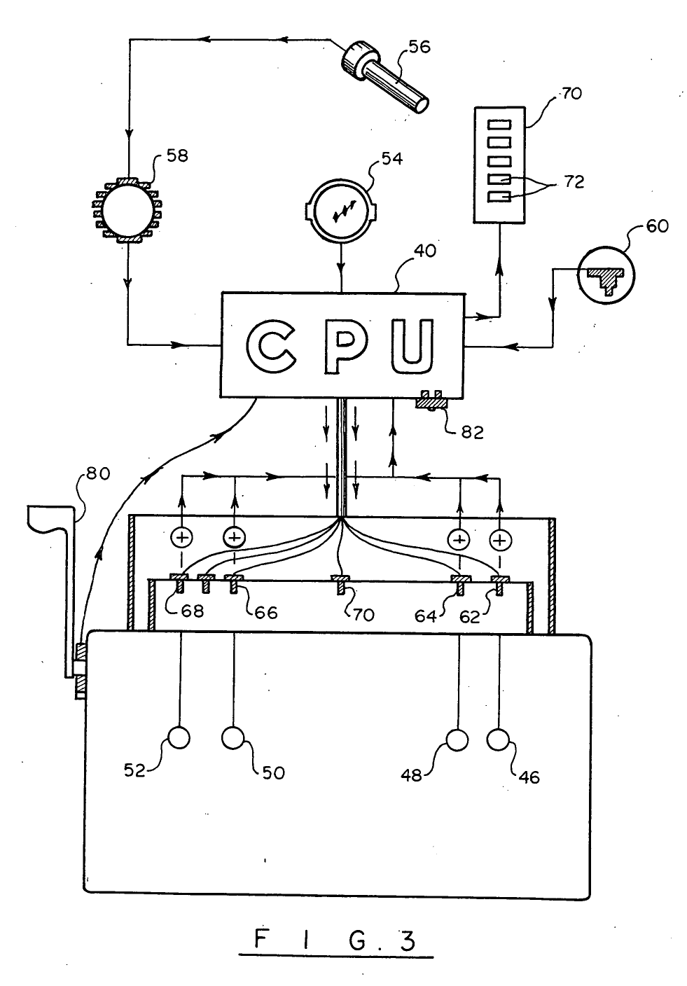

As an alternative to the buttons 42, the present invention provides for the use of a manual handle 80 (FIG. 3) for gear shifting, which allows the user to override the automatic transmission controlled by the central processing unit 40 and retain the transmission in the desired gear.

It is envisioned that the automatic transmission of the present invention can be used on other land vehicles, such as all terrain vehicles, motorized bicycles and the like.

Many changes and modifications can be made in the design of the present invention without departing from the spirit thereof. I therefore pray that my rights to the present invention be limited only by the scope of the appended claims.

I claim:

1. An electronic transmission control system for controlling the functions of a transmission in a vehicle equipped with an engine, the system comprising:
an electronic transmission controller having a memory for storing control parameters for controlling the functions of a transmission and a processor for processing signals indicative of movement of the vehicle;
a user interface device with a display thereon for communicating with the controller;
a plurality of sensor means for detecting functions of the vehicle; and
a connection means from the interface device to the controller for sending overriding signals to the controller and selectively controlling operation of the transmission.

2. The control system of claim 1, wherein the interface device is a push-button panel operationally connected to a display means to allow a user to view, select and alter operating parameters of the transmission.

3. The control system of claim 1, wherein said interface device is a manual shift gear means operationally connected to a display means for allowing a user to view, select and alter operating parameters of the transmission.

4. The Control system of claim 1, wherein said vehicle is a motorcycle.

5. The control system of claim 1, wherein said sensor means comprises at least one sensor for detecting rotational speed of the engine.

6. The control system of claim 5, wherein said sensor means further comprises at least one sensor for detecting speed of movement of the vehicle.

7. The control system of claim 5, wherein said sensor means further comprises at least one solenoid line pressure sensor.

8. The control system of claim 7, wherein said sensor means comprises a solenoid line pressure sensor for each transmission gear.

9. An electronic transmission control system for controlling the functions of a transmission in a motorcycle equipped with an engine, the system comprising:
an electronic transmission controller having a memory for storing control parameters for controlling the functions of the transmission and a processor for processing signals indicative of movement of the motorcycle;
a user interface device with a display thereon for communicating with the controller;
a plurality of sensor means for detecting speed of rotation of the motorcycle engine, speed of movement of the motorcycle, position of a motorcycle throttle, and solenoid line pressure; and
a connection means from the interface device to the controller for sending overriding signals to the controller and selectively controlling operation of the transmission.

10. The control system of claim 9, wherein the interface device is a push-button panel operationally connected to a display means to allow a user to view, select and alter operating parameters of the transmission.

11. The control system of claim 9, wherein said interface device is a manual shift gear means operationally connected to a display means for allowing a user to view, select and alter operating parameters of the transmission.

12. The control system of claim 9, further comprising a visual display means for displaying a current position of transmission gear.
